(19) United States
(12) Patent Application Publication
(10) Pub. No.: US 2006/0139339 A1
(43) Pub. Date: Jun. 29, 2006

(54) Touch location determination using vibration wave packet dispersion

(76) Inventors: Robert J. Pechman, Edina, MN (US); Bernard O. Geaghan, Salem, NH (US); Jerry B. Roberts, Arlington, MA (US)

Correspondence Address: 3M INNOVATIVE PROPERTIES COMPANY, PO BOX 33427, ST. PAUL, MN, 55133-3427, US

(21) Appl. No.: 11/025,389

(22) Filed: Dec. 29, 2004

(51) Int. Cl. G09G 5/00

(52) U.S. Cl. 345/177

(57) ABSTRACT

Methods and devices provide for determination of the location of a touch on a touch plate by sensing dispersive vibrations at each of a number of vibration sensors coupled to a touch plate, the vibrations caused by the touch on the touch plate. An amount of dispersion in the dispersive vibrations sensed at each of the vibration sensors is determined. A distance between the touch and each of the vibration sensors corresponding to the amount of dispersion in the dispersive vibrations sensed at each of the vibration sensors is calculated. The touch location is determined using some or all of the calculated distances.

### FIELD OF THE INVENTION

This invention relates to touch input devices. In particular, the invention relates to touch input devices that use information from vibrations in the touch panel to determine the information about a touch on a touch panel.

### BACKGROUND

Electronic displays are widely used in many aspects of life. Although in the past the use of electronic displays has been primarily limited to computing applications such as desktop computers and notebook computers, as processing power has become more readily available, such capability has been integrated into a wide variety of applications. For example, it is now common to see electronic displays in a wide variety of applications such as teller machines, gaming machines, automotive navigation systems, restaurant management systems, grocery store checkout lines, gas pumps, information kiosks, and hand-held data organizers, to name a few.

Interactive visual displays often include some form of touch sensitive screen. Integrating touch sensitive panels with visual displays is becoming more common with the emergence of next generation portable multimedia devices. One touch detection technology, referred to as Surface Acoustic Wave (SAW), uses high frequency waves propagating on the surface of a glass screen. Attenuation of the waves resulting from contact of a finger with the glass screen surface is used to detect touch location. SAW employs a “time-of-flight” technique, where the time for the disturbance to reach the pickup sensors is used to detect the touch location. Such an approach is possible when the medium behaves in a non-dispersive manner, such that the velocity of the waves does not vary significantly over the frequency range of interest.

### SUMMARY OF THE INVENTION

The present invention is directed to methods and devices for determining the distance between the location of a touch on a touch sensitive plate and one or more sensors based on dispersion of vibrations propagating on the touch sensitive plate caused by the touch. The present invention is also directed to methods and devices for determining the location of a touch on a touch sensitive plate based on dispersion of sensed vibrations resulting from a touch to the touch sensitive plate.

According to an embodiment of the present invention, a method of determining the location of a touch on a touch plate involves sensing dispersive vibrations at each of a number of vibration sensors coupled to a touch plate, the vibrations being caused by the touch on the touch plate. An amount of dispersion in the dispersive vibrations sensed at each of the vibration sensors is determined. The method further involves calculating a distance between the touch and each of the vibration sensors corresponding to the amount of dispersion in the dispersive vibrations sensed at each of the vibration sensors. The touch location is determined using at least some of the calculated distances.

In one approach, calculating the distance between the touch and each of the vibration sensors involves correlating the amount of dispersion at each of the vibration sensors with a distance representing how far the touch is from each of the vibration sensors. Determining the touch location may involve determining the touch location using all of the calculated distances or fewer than all of the calculated distances.

Sensing the dispersive vibrations may involve sensing for predetermined content in the dispersive vibrations sensed at each of the vibration sensors, and the amount of dispersion in the dispersive vibrations may be determined based on the predetermined content. According to one approach, sensing the dispersive vibrations involves sensing for content in the dispersive vibrations associated with each of a number of frequencies, and the amount of dispersion in the dispersive vibrations is determined based on the content associated with each of the frequencies. According to another approach, sensing the dispersive vibrations involves sensing for content in the dispersive vibrations associated with each of a number of frequency bands, and the amount of dispersion in the dispersive vibrations is determined based on the content associated with each of the frequency bands. In yet another approach, sensing the dispersive vibrations involves sensing for content in the dispersive vibrations having predetermined frequency and amplitude characteristics, and the amount of dispersion in the dispersive vibrations is determined based on the predetermined frequency and amplitude characteristics.

Preferably, the dispersive vibrations sensed at each of the vibration sensors comprise first arriving energy of the vibrations caused by the touch on the touch plate. Determining the touch location may involve determining intersections of circular arcs computed using all or some of the calculated distances.

In accordance with another embodiment, a touch sensing device includes a touch panel and a number of sensors coupled to the touch panel. The sensors are configured to sense dispersive vibrations in the touch panel and generate a sense signal responsive to the sensed dispersive vibrations. A controller is coupled to the sensors and configured to calculate a distance between a touch on the touch panel and each of the sensors based on an amount of dispersion present in the sense signal generated by each of the sensors. The controller may also be configured to determine a location of the touch on the touch panel using at least some of the calculated distances. A touch sensing device of the present invention may implement one or more of the processes described above or below to calculate the distance between a touch and touch sensors, arid to determine a location of the touch on the touch panel.

The above summary of the present invention is not intended to describe each disclosed embodiment or every implementation of the present invention. The Figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 shows a touch sensitive device that incorporates features and functionality for detecting bending wave vibrations and determining touch locations using dispersion of detected bending wave vibrations in accordance with embodiments of the invention;

FIG. 2 is a flow diagram depicting a methodology for determining touch location that directly exploits vibration wave packet dispersions in accordance with an embodiment of the present invention;

FIG. 3 is a flow diagram depicting a methodology for determining touch location that directly exploits vibration wave packet dispersions in accordance with another embodiment of the present invention;

FIG. 4 shows a simplified waveform, E(t), of minimally dispersed acoustic signal energy received by a sensor of a touch sensitive device according to an example illustrative of the principles of the present invention;

FIG. 5 shows a simplified waveform, E(t), of widely dispersed acoustic signal energy received by a sensor of a touch sensitive device according to an example illustrative of the principles of the present invention;

FIG. 6 shows a touch panel of a type with which the principles of the present invention may be practiced;

FIG. 7A is a graphical representation of energy received at the four sensors shown in FIG. 6 following a finger touch to a point LLT indicated in FIG. 6;

FIG. 7B is a graphical representation of energy received at the same four sensors following a stylus touch to point LLT indicated in FIG. 6;

FIGS. 8A-8D are spectrographs depicting data calculated from the touch data shown graphically in FIGS. 7A and 7B, resulting from touching the point LLT indicated on FIG. 6 using a finger;

FIGS. 9A-9D are spectrographs depicting data calculated from the touch data shown graphically in FIGS. 7A and 7B, resulting from touching the point LLT indicated on FIG. 6, using a hard plastic stylus;

FIG. 10 is graphical data representative of a vertical slice through the 6KHz frequency band of FIG. 8B; and

FIG. 11 is graphical data representative of a vertical slice through the 24KHz frequency band of FIG. 8B.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

In the following description of the illustrated embodiments, reference is made to the accompanying drawings that form a part hereof, and in which is shown by way of illustration, various embodiments in which the invention may be practiced. It is to be understood that the embodiments may be utilized and structural changes may be made without departing from the scope of the present invention.

The present invention relates to touch activated, user interactive devices that sense vibrations that propagate through a touch substrate for sensing by a number of touch transducers. More particularly, the present invention relates to a touch sensing apparatus that employs transducers configured to sense bending wave vibrations that propagate through a touch substrate. Systems and methods of the present invention are implemented to exploit the phenomena of vibration wave packet dispersion to determine the location of a touch to a touch substrate. A touch location determination approach of the present invention uses vibration wave packet dispersion itself to perform distance measurements from which a touch location may be computed.

These and other features and capabilities are described below in greater detail. A touch sensing apparatus implemented in accordance with the present invention may incorporate one or more of the features, structures, methods, or combinations thereof described herein. It is intended that such a device or method need not include all of the features and functions described herein, but may be implemented to include selected features and functions that, in combination, provide for useful structures and/or functionality.

The term bending wave vibration refers to an excitation, for example by the contact, which imparts some out of plane displacement to a member capable of supporting bending wave vibrations. Many materials bend, some with pure bending with a perfect square root dispersion relation and some with a mixture of pure and shear bending. The dispersion relation describes the dependence of the in-plane velocity of the waves on the frequency of the waves.

In vibration sensing touch input devices that include piezoelectric sensors, for example, vibrations propagating in the plane of the touch panel plate stress the piezoelectric sensors, causing a detectable voltage drop across the sensor. The signal received can be caused by a vibration resulting directly from the impact of a direct touch input or the input of energy with a trace (friction), or by a touch input influencing an existing vibration, for example by attenuation of the vibration. The signal received can also be caused by an unintended touch input, such as a touch input resulting from user handling or mishandling of the touch input device, or from environmental sources external to, but sensed by, the touch input device.

When the propagation medium is a dispersive medium, the vibration wave packet, which is composed of multiple frequencies, becomes spread out and attenuated as it propagates, making interpretation of the signal difficult. As such, it has been proposed to convert the received signals so they can be interpreted as if they were propagated in a non-dispersive medium. Exemplary techniques for addressing vibration wave packet dispersion and producing representative signals corrected for such dispersion are disclosed in International Publications WO 2003/005292 and WO 01/48684, which are incorporated herein by reference.

According to one approach that operates to correct for vibration wave packet dispersion, for example, a first sensor mounted on a structure capable of supporting bending waves measures a first measured bending wave signal. A second sensor is mounted on the structure to determine a second measured bending wave signal. The second measured bending wave signal is measured simultaneously with the first measured bending wave signal. A dispersion corrected function of the two measured bending wave signals is calculated, which may be a dispersion corrected correlation function, a dispersion corrected convolution function, a dispersion corrected coherence function or other phase equivalent function. The measured bending wave signals are processed to calculate information relating to the contact by applying the dispersion corrected function. Details concerning this approach are disclosed in previously incorporated International Publications WO 2003/005292 and WO 01/48684.

Such techniques operate to correct for the vibration wave packet dispersion phenomena. In stark contrast, techniques of the present invention exploit such phenomena for purposes of performing touch location determinations.

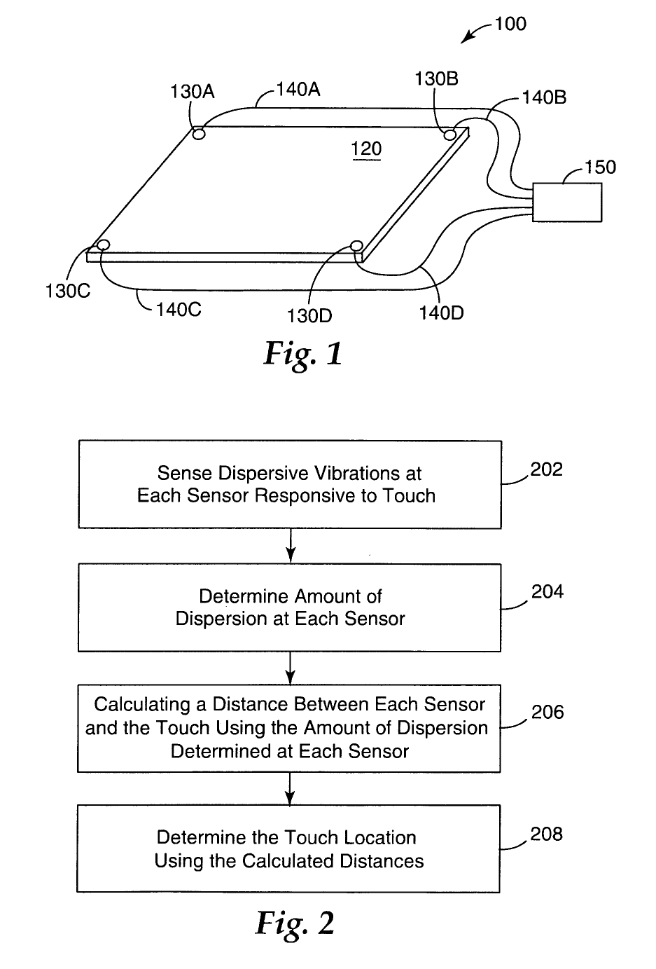

Turning now to FIG. 1, there is illustrated one configuration of a touch sensitive device 100 that incorporates features and functionality for detecting bending wave vibrations and determining touch location using dispersion of detected bending wave vibrations. According to this embodiment, the touch sensitive device 100 includes a touch substrate 120 and vibration sensors 130 coupled to an upper surface of the touch substrate 120. In this illustrative example, the upper surface of the touch substrate 120 defines a touch sensitive surface. Although sensors 130 are shown coupled to the upper surface of the touch substrate 120, the sensors 130 can alternatively be coupled to the lower surface of the touch substrate 120. In another embodiment, one or more sensors 130 may be coupled to the upper surface while one or more other sensors 130 may be coupled to the lower surface of the touch substrate 120. The vibration sensors 130A-130D can be coupled to touch plate 120 by any suitable means, for example using an adhesive, solder, or other suitable material, so long as the mechanical coupling achieved is sufficient for vibrations propagating in the touch plate can be detected by the vibration sensors. Exemplary vibration sensors and vibration sensor arrangements are disclosed in co-assigned U.S. patent applications U.S. Ser. No. 10/440,650 and U.S. Ser. No. 10/739,471, which are fully incorporated into this document.

Touch substrate 120 may be any substrate that supports vibrations of interest, such as bending wave vibrations. Exemplary substrates 120 include plastics such as acrylics or polycarbonates, glass, or other suitable materials. Touch substrate 120 can be transparent or opaque, and can optionally include or incorporate other layers or support additional functionalities. For example, touch substrate 120 can provide scratch resistance, smudge resistance, glare reduction, anti-reflection properties, light control for directionality or privacy, filtering, polarization, optical compensation, frictional texturing, coloration, graphical images, and the like.

In general, the touch sensitive device 100 includes at least three sensors 130 to determine the position of a touch input in two dimensions, and four sensors 130 (shown as sensors 130A, 130B, 130C, and 130D in FIG. 1) may be desirable in some embodiments, as discussed in International Publications WO 2003/005292 and WO 0148684, and in co-assigned U.S. Published Application 2001/0006006 (U.S. Ser. No. 09/746,405, filed Dec. 26, 2000), which is fully incorporated into this document.

In the present invention, sensors 130 are preferably piezoelectric sensors that can sense vibrations indicative of a touch input to touch substrate 120. Useful piezoelectric sensors include unimorph and bimorph piezoelectric sensors. Piezoelectric sensors offer a number of advantageous features, including, for example, good sensitivity, relative low cost, adequate robustness, potentially small form factor, adequate stability, and linearity of response. Other sensors that can be used in vibration sensing touch sensitive devices 100 include electrostrictive, magnetostrictive, piezoresistive, acoustic, and moving coil transducers/devices, among others.

In one embodiment, all of the sensors 130 are configured to sense vibrations in the touch substrate 120. In another embodiment, one or more of the sensors 130 can be used as an emitter device to emit a signal that can be sensed by the other sensors 130 to be used as a reference signal or to create vibrations that can be altered under a touch input, such altered vibrations being sensed by the sensors 130 to determine the position of the touch. An electrodynamic transducer may be used as a suitable emitter device. Moreover, one or more of the sensors 130 can be configured as a dual-purpose sense and excitation transducer, for example as disclosed in previously incorporated International Publications WO 2003/005292 and WO 01/48684 as well as co-assigned U.S. patent application Ser. No. 10/750,502, which is fully incorporated into this, document.

Many applications that employ touch sensitive devices 100 also use electronic displays to display information through the touch sensitive devices 100. Since displays are typically rectangular, it is typical and convenient to use rectangular touch sensitive devices 100. As such, the touch substrate 120 to which the sensors 130 are affixed is typically rectangular in shape, it being understood that other geometries may be desirable.

According to one configuration, the sensors 130A, 130B, 130C, 130D are preferably placed near the corners of the touch substrate 120. Because many applications call for a display to be viewed through the touch sensitive devices 100, it is desirable to place the sensors 130A-D near the edges of the touch substrate 120 so that they do not undesirably encroach on the viewable display area. Placement of the sensors 130A-D at the corners of a touch substrate 120 can also reduce the influence of reflections from the panel edges.

The contact sensed by the touch sensitive device 100 may be in the form of a touch from a stylus, which may be in the form of a hand-held pen. The movement of a stylus on the touch substrate 120 may generate a continuous signal, which is affected by the location, pressure and speed of the stylus on the touch substrate 120. The stylus may have a flexible tip, e.g. of rubber, which generates bending waves in the touch substrate 120 by applying a variable force thereto. The variable force may be provided by the tip, which alternatively adheres to or slips across a surface of the touch substrate 120. Alternatively, the contact may be in the form of a touch from a finger that may generate bending waves in the touch substrate 120, which may be detected by passive and/or active sensing. The bending waves may have frequency components in the ultrasonic region (>20 kHz).

The touch sensitive device 100 shown in FIG. 1 is communicatively coupled to a controller 150. The sensors 130A-D are electrically coupled to the controller 150 via wires 140A-D or a printed electrode pattern developed on the touch substrate 120. The controller 150 typically includes front-end electronics that applies signals to the sensors 130 and measures signals or signal changes. In other configurations, the controller 150 may further include a microprocessor in addition to front-end electronics.

In a typical deployment configuration, the touch sensitive device 100 is used in combination with a display of a host computing system (not shown) to provide for visual and tactile interaction between a user and, the host computing system. The host computing system may include a communications interface, such as a network interface, to facilitate communications between a touch panel system that incorporates touch sensitive device 100 and a remote system. Various touch panel system diagnostics, calibration, and maintenance routines, for example, may be implemented by cooperative communication between the touch panel system and the remote system.

Turning now to FIG. 2, there is illustrated a methodology for determining touch location that directly exploits vibration wave packet dispersions in accordance with one embodiment of the present invention. It is assumed in this illustrative embodiment that a number of sensors are provided for sensing bending wave vibrations propagating in a touch sensitive substrate. As is shown in FIG. 2, dispersive vibrations caused by a touch to the touch sensitive substrate are sensed 202 at each of the sensors. An amount of dispersion associated with the sensed dispersive vibrations is determined 204 at each of the sensors. A distance between each of the sensors and the touch event is calculated 206 using the amount of dispersion determined at each of the sensors. A touch location is determined 208 using the calculated distances.

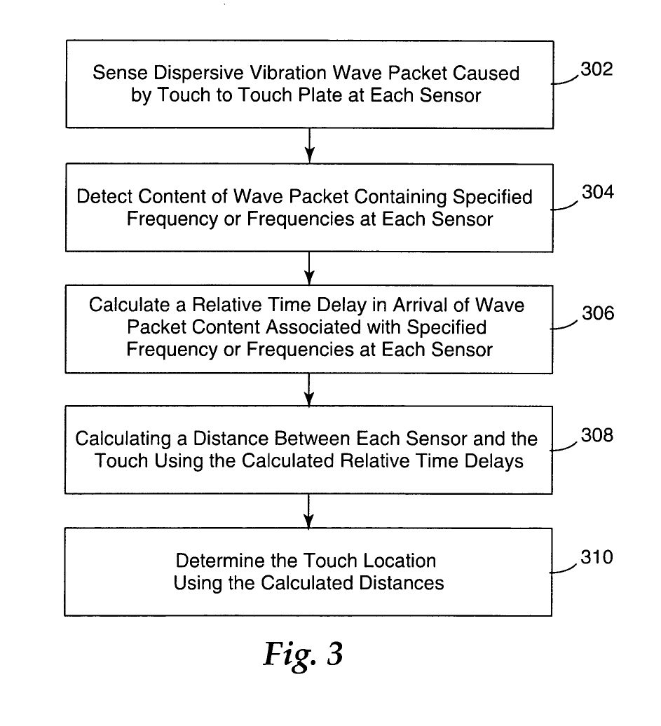

FIG. 3 illustrates a methodology for determining touch location that directly exploits vibration wave packet dispersions in accordance with another embodiment of the present invention. As in the previous example, it is assumed in this illustrative embodiment that a number of sensors are provided for sensing bending wave vibrations propagating on a touch sensitive substrate. As is shown in FIG. 3, a dispersive vibration wave packet caused by a touch to a touch sensitive substrate is sensed 302 at each sensor. Content of the wave packet containing a specified frequency or frequencies is detected 304 at each sensor. A relative time delay in arrival of wave packet content associated with the specified frequency or frequencies is calculated 306 at each sensor. A distance between each sensor and the touch event is calculated 308 using the relative time delays. The location of the touch may then be determined 310 using the calculated distances.

As was discussed previously, known systems that measure dispersive vibration waves in a touch panel plate, such as those that use measurements of time-of-flight of acoustic waves from a touched point to several sensors, also correct for the amount of dispersion of received waves. In contrast, systems of the present invention may be implemented to measure touch-position using only the differences in wave dispersion to calculate time and distance of wave travel.

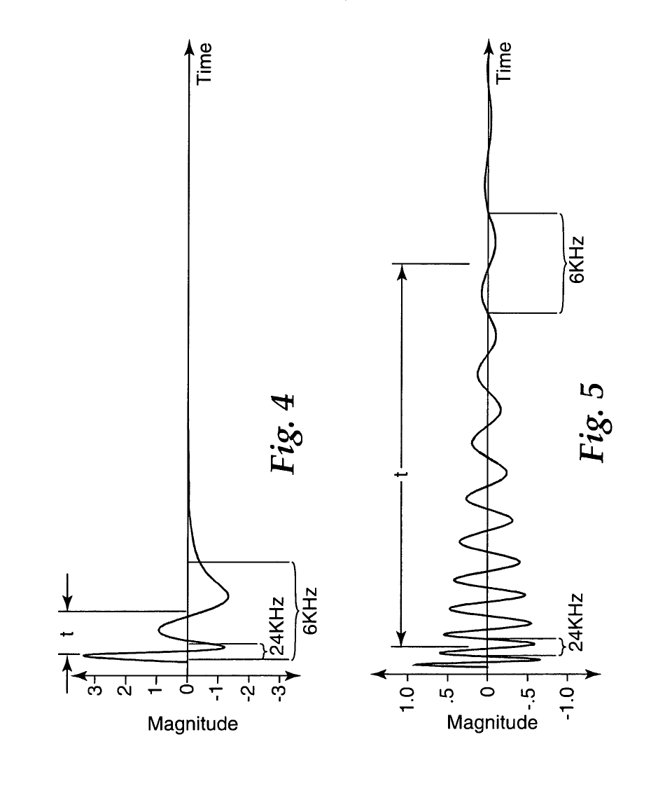

Referring now to FIG. 4, there is shown a simplified waveform E(t) of minimally dispersed acoustic signal energy received by one sensor of a touch sensitive device, such as device 100 of FIG. 1, as a result of a tap touch. Given an impulse-like touch signal, all frequencies are received by the sensor roughly simultaneously. This waveform may be received when the touched point is very close to a sensor. FIG. 5 shows a simplified waveform E(t) of widely dispersed acoustic signal energy received by one sensor of a touch sensitive device, such as device 100 of FIG. 1, as a result of an impulse-like tap touch. This waveform may be received when the touched point is some distance away from a sensor. Note that higher frequencies are received first, followed by lower and lower frequencies, according to the dispersion characteristics of a touch panel.

Velocity of bending wave vibrations, such as anti-symmetrical Lamb waves, in a plate is proportional to the square root of frequency, as shown in Equation 1 below. Waves of different frequencies disperse over time and distance traveled in the plate.
v=\sqrt{k·T·f} Equation 1
where, v=wave velocity in inches/second, f=frequency in Hz, k=constant (dimensions: inches/second)—a function of bending stiffness and mass per unit area of the plate used, and T=thickness of the plate in inches. For a soda lime glass plate, such as was used in the illustrative examples herein, k=3.783*105, and given a thickness of 2.14 mm=0.084 inches, (k*T)=3.1891*104.

### EXAMPLE 1

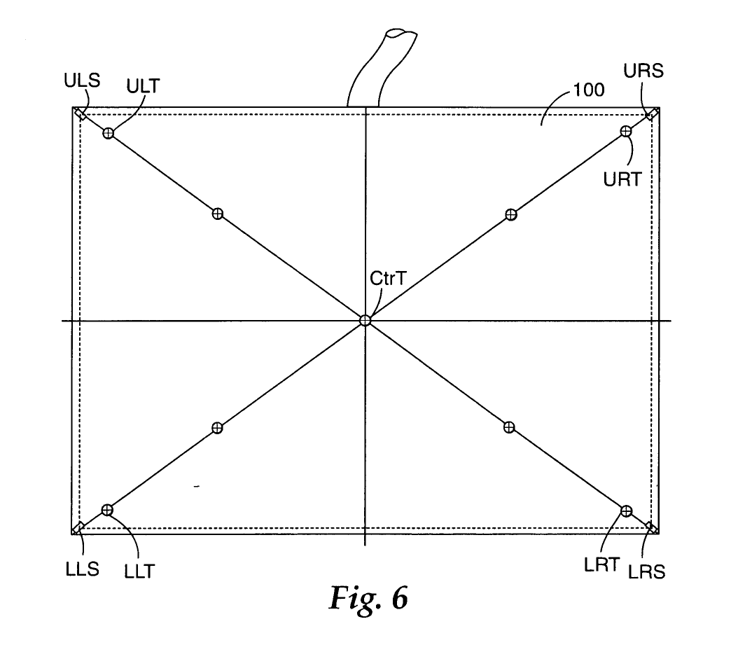

In this illustrative example, it is assumed that a touch input is applied to a touch sensitive device, such as device 100 of FIG. 1 or FIG. 6, and Lamb waves radiate from the touch point. The arrival time of selected frequencies (or narrow bands of frequency) present in this signal may be detected. Synchronous demodulation may be used to process the signals received at each sensor, or analog filters, or preferably digital filtering may be used for selecting frequencies. While two frequencies are sufficient to measure dispersion time, more frequencies may be measured to ensure adequate signal magnitude at a minimum of two frequencies.

By way of example, if two frequencies (e.g., 6 KHz and 24 KHz) of sufficient amplitude are selected, the time difference, At, between receipt of energy at each of these frequencies at a first transducer can be determined. Similarly, the time difference between receipt of the same two frequencies at each of the remaining transducers can be determined. The time of arrival differences will be proportional to the distance between the touched point and the respective transducer according to the dispersion relation in Equation 1 above. From this information, circular arcs can be drawn, and a two, three, or four-way intersection of arcs indicates where the touch originated, using known triangulation methods.

TABLE 1

| | | Distance (in.) | | | | |
|---|---|---|---|---|---|---|
| Frequency | Velocity | 1 | 11.84 | 14.63 | 18.78 | 19.78 |
| KHz | in/mS | LLS | ULS | LRS | URS | MAX |
| 6 | 13.8 | 0.07 | 0.90 | 1.06 | 1.36 | 1.43 |
| 9 | 16.9 | 0.06 | 0.74 | 0.86 | 1.11 | 1.17 |
| 12 | 19.6 | 0.05 | 0.64 | 0.75 | 0.96 | 1.01 |
| 15 | 21.9 | 0.05 | 0.57 | 0.67 | 0.86 | 0.91 |
| 18 | 24.0 | 0.04 | 0.52 | 0.61 | 0.78 | 0.82 |
| 21 | 27.7 | 0.04 | 0.48 | 0.57 | 0.73 | 0.77 |
| 24 | 27.7 | 0.04 | 0.45 | 0.53 | 0.68 | 0.72 |
| 27 | 29.3 | 0.03 | 0.42 | 0.50 | 0.64 | 0.67 |
| 30 | 30.9 | 0.03 | 0.40 | 0.47 | 0.61 | 0.64 |
| 36 | 33.9 | 0.03 | 0.37 | 0.43 | 0.55 | 0.58 |
| 40 | 35.7 | 0.03 | 0.35 | 0.41 | 0.53 | 0.56 |

FIG. 6 shows a touch panel 100 of a type with which the principles of the present invention may be practiced. Four sensors at the corners, LLS, ULS, LRS, and URS, measured Lamb waves as they arrive from a touched point. Touch points marked ULT, URT, CtrT, etc. indicate points that were touched to generate test data shown herein. Test data was taken by touching all indicated points with a finger and also with a hard plastic . stylus. Data from point LLT will be used herein as an example.

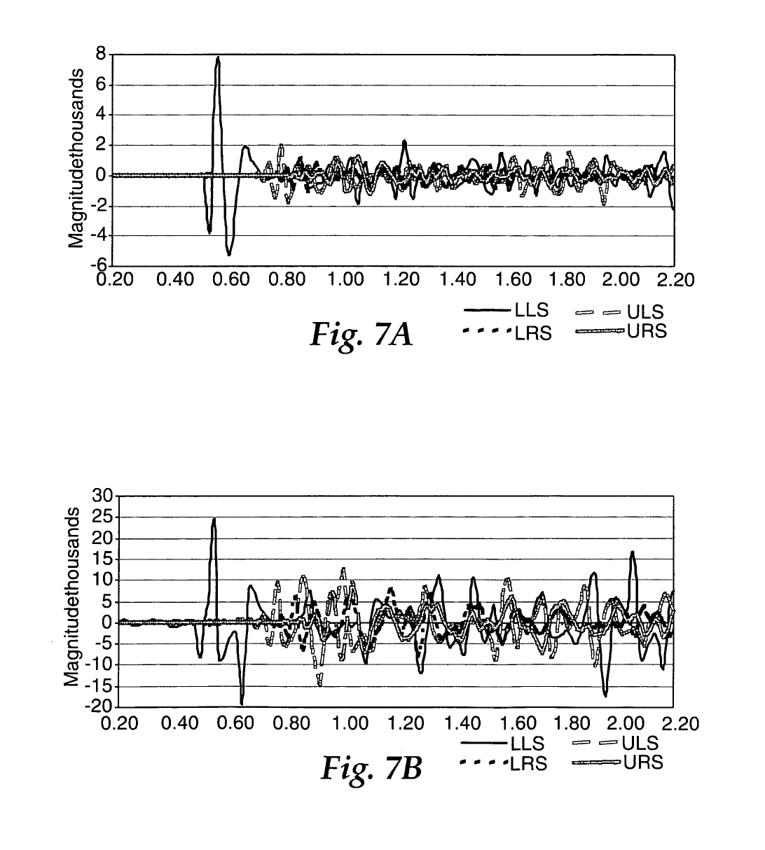

FIG. 7A is a graphical representation of energy received at the four sensors, LLS, ULS, LRS, and URS, shown in FIG. 6 following a finger touch to point LLT indicated in FIG. 6. FIG. 7B is a graphical representation of energy received at the same four sensor fallowing a stylus touch to point LLT indicated in FIG. 6. The distances from the LLT touched point to sensors LLS, ULS, LRS, and URL are 1, 11.84, 14.63, and 18.78 inches, respectively.

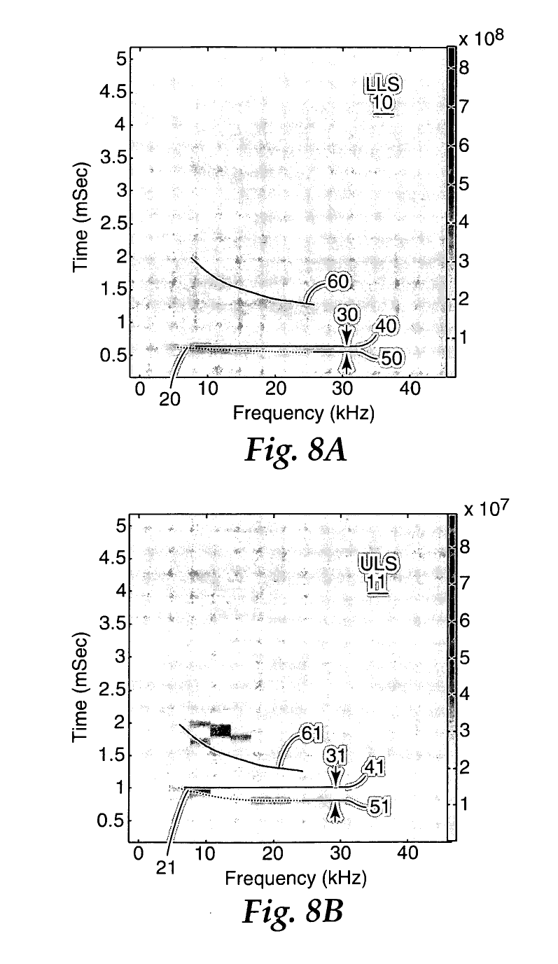

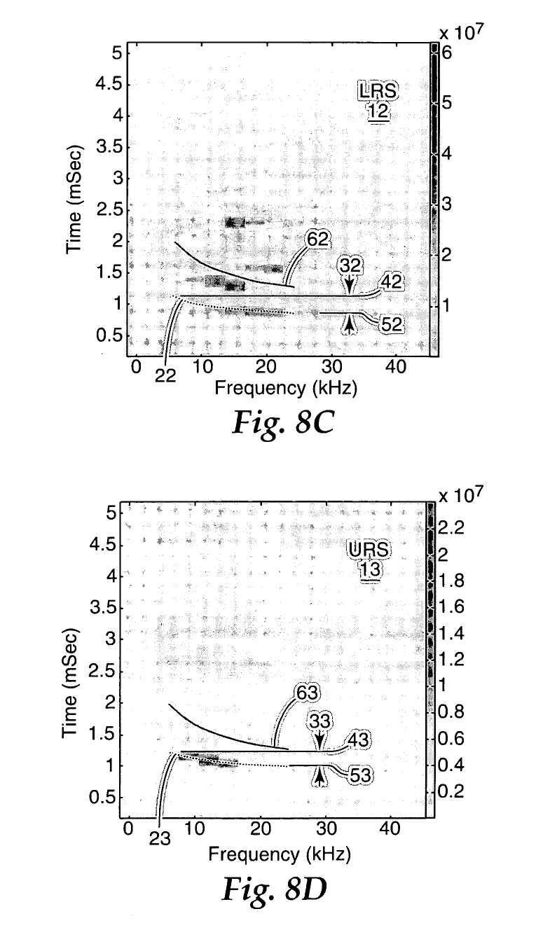

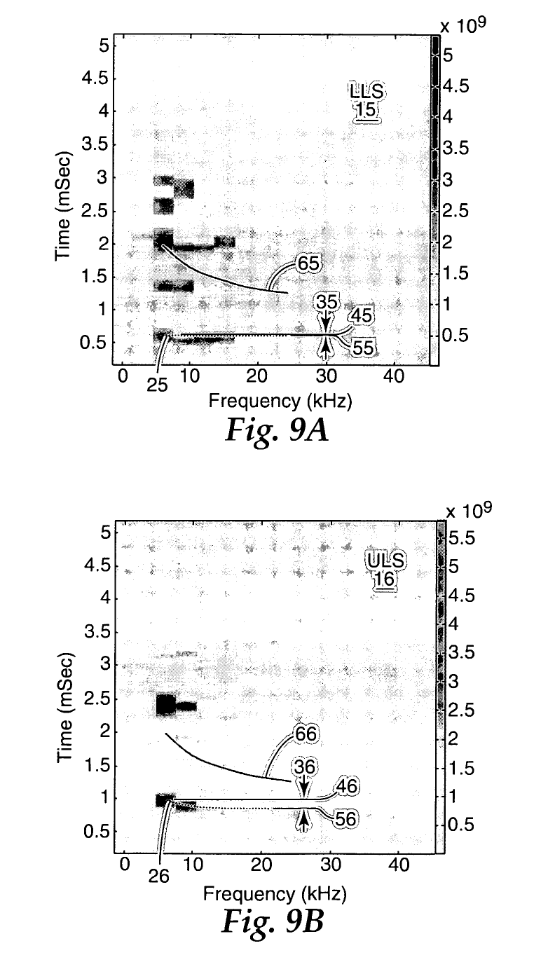

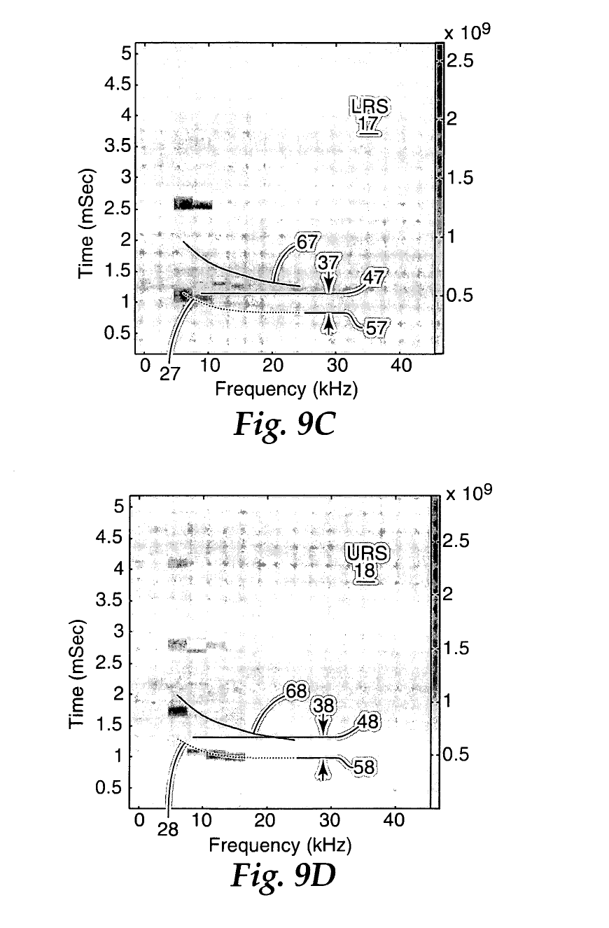

Data in the spectrographs 10-13 and 15-18 in FIGS. 8A-8D and 9A-9D, respectively, were calculated from the same touch data shown in FIGS. 7A and 7B, resulting from touching the point LLT indicated on FIG. 6. Spectrographs 10-13 of FIG. 8A-8D show data received by sensors LLS, ULS, LRS, and URS respectively, using a finger touch. Data for spectrographs 15-18 in FIGS. 9A-9D were made by touching the point LLT, indicated on FIG. 6, using a hard plastic stylus.

Referring to FIGS. 8A-8D and 9A-9D, the lines 60-63 and 65-68 are graphs of values from Table 1 above, calculated from Equation 1 above, representing the maximum limit to receive primary (non-reflected) energy from any possible touch point on touch panel 100 of FIG. 6. Energy measured at times greater than the limits indicated by lines 60-63 are not used in calculation of touch points. Dashed lines 20-23 and 25-28 of FIGS. 8A-8D and 9A-9D, respectively, are generated by connecting points of maximum measured energy on the spectrograph within the time limits indicated by the lines 60-63 and 65-68.

With continued reference to FIGS. 6 and 8A-9D, the sensor LLS receives energy first among the four sensors, at time 0.52 ms=t₀, represented by line 50 in spectrograph 10 of FIG. 8A. Subsequently, first energy arrives at sensor ULS at a time shown as line 51 in FIG. 8B. Lines 52 and 53 of FIGS. 8C and 8D indicate arrival of first energy at sensors LRS and URS, respectively. First energy arrives at higher frequencies, as can be seen in the spectrographs of FIGS. 8A-9D as lines 50-53 and 55-58. At lower frequencies, for example 6 KHz, energy arrives at times indicated by lines 40-43 in FIGS. 8A-8D and lines 45-48 in FIGS. 9A-9D in spectrographs 10-13 and 15-18, respectively

The difference in time of arrival of 24 KHz (i.e., high) vs. 6 KHz (i.e., low) energy is indicated graphically as intervals 30-33 and 35-38 in FIGS. 8A-8D and 9A-9D, respectively. The distance from each sensor, LLS, ULS, LRS, URS, to a touched point (e.g., LLT) may be calculated from intervals 30-33 and 35-38.

For each frequency of interest, velocity, v, may be calculated from Equation 1 above, then the difference in distance from a touched point to may be calculated using:
Distance=(t₂ −t₁)*(v₁*v₂)/(v₁−v₂) Equation 2
where, vₙ=velocity at a selected frequency and tₙ=arrival time of energy at the selected frequency.

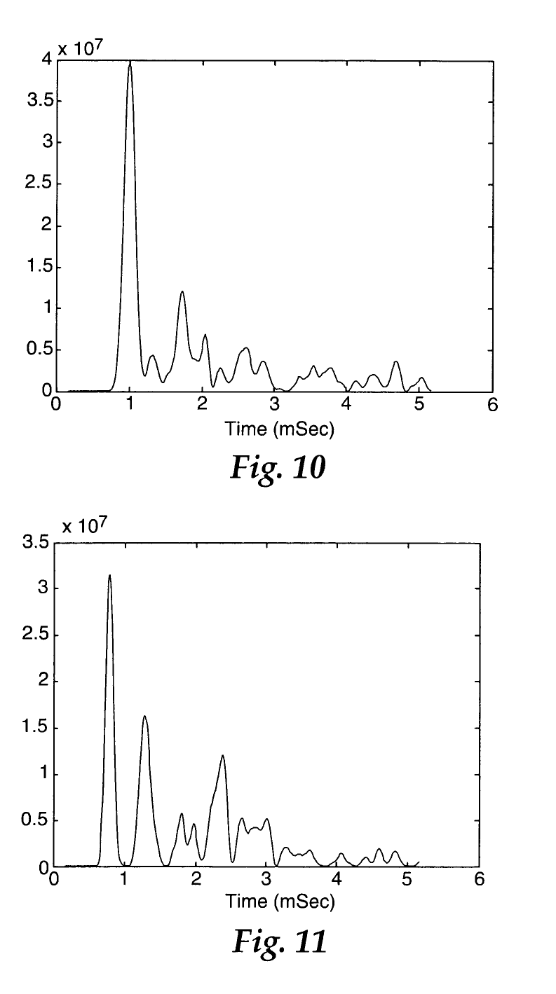

FIGS. 10 and 11 show typical data that was used to generate the spectrograms in FIGS. 8A-9D. FIG. 10 is a vertical slice through the 6 KHz frequency band of FIG. 8B. FIG. 11 is a vertical slice through the 24 KHz frequency band of FIG. 8B. The method of measurement used for FIGS. 8A-11 involves Fast Fourier Transforms (FFT's) with the window set at 32 samples and a Hanning shape applied. Data sets of 512 points were used from each sensor for these examples, but in the 20 inch touch panel example used, all events of interest happen within 128 periods of the exemplary 96 KHz sampling system. Also, it is not necessary to generate FFT bins (correlations) at a large number of frequencies. In the examples used, frequencies of 6, 9, 12, 15, 18, 21, and 24 KHz were used, as can be seen in FIGS. 8A-9D. Although only two frequencies are required, a practical consideration is that there is not always sufficient energy at two selected frequencies to assure adequate signal to noise ratio of measurements.

Energy, E(t), of signals received at each sensor may be described by the following equation:
E(t)=S(t)*F(t) Equation 3
where, S(t) is the source signal, typically a touch of a finger or stylus onto the panel, and F(t) is the transfer function of the panel, receiver sensor, and measurement system. Ideally, S(t) would be an impulse, but in fact it is a complex function that generates energy at multiple frequencies over a period of initial touchdown of a finger on a panel .

A non-impulse source signal, S(t), may contribute energy at differing frequencies over time, creating a dispersed initial signal that is additionally dispersed by the transfer function of the plate, as described by Equation 1 above. Dispersion based on transfer function F(t) is used to determine distance of a touch point, and this must be resolved in the presence of a dispersed signal.

In various applications, it may be desirable to increase the Signal/Noise (S/N) ratio of the measurement system. One consideration to improving the signal-to-noise ratio involves knowledge of the size of the touch sensitive plate prior to performing signal analysis. This knowledge allows for the time window of touch events to be limited to the maximum time of travel of waves within the known distance. By way of example, for a plate of 20 inches measured diagonally, the slowest waves of about 4 KHz will travel the full diagonal distance in about 2.25 ms (calculated from Equation 1), so data received after this time are not useful for calculating dispersion of the primary (non-reflected) wave front. Plate size may be entered as a constant during installation of a touch panel, or it may be derived from measurements using an interactive set-up procedure prior to normal use.

The accuracy of touch location determinations may be improved by using touch location measurements that are in agreement and discarding a measurement(s) that is suspect. For example, the distance of a touch from each corner of a touch plate is related to known distances from other corners, i.e., the four touch signals must resolve to a common point. Given four measurements from sensors, two or three that provide the closest results may be used to calculate the touched point, using a known triangulation technique. By way of further example, a coarse touch location may be obtained by a simple measurement of time of arrival of first energy at each sensor. This typically yields an estimate of touch position within +/−10% that may be used to select data for subsequent calculations.

### EXAMPLE 2

According to other embodiments, touch energy arriving at each sensor may be filtered into a high frequency band and a low frequency band. Dispersion skews the arrival time at a sensor of the wave packets seen in the two bands. In different implementations, the two derived signals representative of higher and lower frequencies may be formed by linear filters of a number of different pass-band shapes, such as square, Gaussian, sync, or the like. The pass-bands may overlap to some degree, or may be separated by a gap of largely unrepresented intermediate frequencies.

Touch sensitive panels with large border areas (i.e., delayed reflections) or excellent edge absorption may employ the following procedure. For each sensor, square the high-frequency derived signal over the time region of significant wave-packet amplitude, then determine the centroid of this power-time curve as the arrival time of the high-frequency packet. In like manner, determine the arrival time of the low-frequency packet. Determine the distance of the touch event from each sensor, using the arrival-time differences, the central frequencies of the high and low frequency filters used, and the dispersion relation of the medium. Determine a touch location and an error estimate using the set of computed sensor-to-event distances, using the procedure at the end of the method of the following illustrative example. Report the location estimate if the error estimate is sufficiently small.

### EXAMPLE 3

Some touch sensitive panels may create large edge reflections that arrive at the sensors with relatively small delay in comparison with the direct path signal. Such touch sensitive panels may benefit from timing the arrival of the leading edges of the high and low frequency wave packets, rather than trying to find their centroids. This may be accomplished by the following procedure:

A. Touch Analysis

1. Set working arrival thresholds to a predetermined multiple, such as 0. 1, times the amplitudes representative of the early arrival signal at each sensor. The early arrival signal may be taken to be the portion extending for a predetermined interval, such as 0.1 ms, after the first rise above quiescence. The representative early-arrival amplitude may be taken to be the square root of the average early arrival power.

2. Adjust the relative high and low frequency arrival thresholds to minimize the error estimate:
a. For each sensor signal, extract arrival times from the moments when the high frequencies and the low frequencies first exceed the associated arrival thresholds. Obtain the arrival-time differences between high and low frequencies for each sensor signal.
b. Compute location and error estimates from these arrival-time differences.
c. While adjusting an optimizing parameter that we may call P1, and that may have a starting value of unity, obtain a temporary set of high frequency arrival-time thresholds from P1 times the high frequency working values, and obtain a temporary set of low frequency arrival-time thresholds from 1/P1 times the low frequency working values. Repeat steps 2a and 2b as necessary to determine the value of P1 yielding the least error estimate. Assign the associated temporary thresholds as the working thresholds.

3. Scale the arrival-time differences to minimize the error estimate:
a. For each sensor signal, extract arrival times from the moments when the high frequencies and the low frequencies first exceed the associated arrival thresholds. Obtain the arrival-time differences between high and low frequencies for each sensor signal.
b. Employing an optimizing parameter that we may call P2, and that may have a starting value of unity, compute location and error estimates from P2 times these arrival-time differences.
c. While adjusting P2, repeat steps 3a and 3b as necessary to determine the value of P2 yielding the least error estimate.
d. If the error estimate is below a predetermined value, report the location estimate as a touch location.

B. Touch Location Determination

To determine a location estimate and an error estimate, the following procedure may be implemented:

1. For each pair of sensors adjacent along the periphery of the screen:
a. If the sum of the two sensor-to-event distances is greater than the sensor-to-sensor distance, form a trial point at the on-screen point which lies at the specified distance from each sensor.
b. If the sum of the two sensor-to-event distances is less than the sensor-to-sensor distance, form a trial point at that point along the line between the sensors such that the distance from this point to the sensors in question lies in the same ratio as the specified distances.

2. Form a location estimate at the mean value of the trial points.

3. Form an error estimate equal to the sum of the squared distances of the trial points from the location estimate.

It may, in some instances, be advantageous to determine the first threshold crossing, or trigger time, of an arriving wave packet by employing the following variation:

1. Extract the sample points representing local maxima of the absolute value of the signal amplitude (alternatively, of the squared signal amplitude). Collect these sample points for the early-rise portion of the wave packet.

2. Obtain a smooth approximating curve to these points by a least-squares fit. Such fit may employ, for instance, a low-order polynomial, such as a quadratic departing tangentially from zero amplitude, or an exponential rise departing asymptotically from zero amplitude. The form and parametric constraints placed on this fit may be chosen to reflect a priori knowledge of the expected form of the wave packets.

3. Determine the threshold crossing time to be the time at which the smooth-fit curve first crosses the given threshold.

From the above discussion, it can be seen that touch location can be determined from exploiting the separation in arrival time of different frequencies of a dispersive vibration wave packet resulting from a touch on a touch sensitive plate. The time interval between the arrival of any two frequencies or frequency bands can be determined by the non-limiting illustrative techniques described above. As is discussed above, different frequencies or frequency bands of a dispersive vibration wave packet can be separated by digital or analog filtering, and the arrival time of each specific frequency or frequency band can be separately determined.

According to another approach, a sensed dispersive vibration wave packet resulting from a touch event can be cross-correlated with a baseline waveform having a desired frequency or frequencies. This cross-correlation process reveals the onset or arrival of the particular frequency or frequencies in the sensed dispersive vibration wave packet. Since the velocities of the two frequencies are known, the distance of the touch event can be determined based on the separation time. Additional details of this and other techniques that can be adapted for use with methods and devices of the present invention are described in U.S. Pat. No. 5,635,643, which is incorporated herein by reference.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. A method for determining a location of a touch on a touch sensitive device having a touch plate and a plurality of vibration sensors configured to sense vibrations propagating in the touch plate, the method comprising:
sensing dispersive vibrations at each of the vibration sensors, the vibrations caused by the touch on the touch plate;
determining an amount of dispersion in the dispersive vibrations sensed at each of the vibration sensors;
calculating a distance between the touch and each of the vibration sensors corresponding to the amount of dispersion in the dispersive vibrations sensed at each of the vibration sensors; and
determining the touch location using at least some of the calculated distances.

2. The method of claim 1, wherein calculating the distance between the touch and each of the vibration sensors comprises correlating the amount of dispersion at each of the vibration sensors with a distance representing how far the touch is from each of the vibration sensors.

3. The method of claim 1, wherein determining the touch location comprises determining the touch location using all of the calculated distances.

4. The method of claim 1, wherein sensing the dispersive vibrations comprises sensing for predetermined content in the dispersive vibrations sensed at each of the vibration sensors, and the amount of dispersion in the dispersive vibrations is determined based on the predetermined content.

5. The method of claim 1, wherein sensing the dispersive vibrations comprises sensing for content in the dispersive vibrations associated with each of a plurality of frequencies, and the amount of dispersion in the dispersive vibrations is determined based on the content associated with each of the plurality of frequencies.

6. The method of claim 1, wherein sensing the dispersive vibrations comprises sensing for content in the dispersive vibrations associated with each of a plurality of frequency bands, and the amount of dispersion in the dispersive vibrations is determined based on the content associated with each of the plurality of frequency bands.

7. The method of claim 1, wherein sensing the dispersive vibrations comprises sensing for content in the dispersive vibrations having predetermined frequency and amplitude characteristics, and the amount of dispersion in the dispersive vibrations is determined based on the predetermined frequency and amplitude characteristics.

8. The method of claim 1, wherein the dispersive vibrations sensed at each of the vibration sensors comprise first arriving energy of the vibrations caused by the touch on the touch plate.

9. The method of claim 1, wherein determining the touch location comprises determining intersections of circular arcs computed using the at least some of the calculated distances.

10. The method of claim 1, wherein determining the touch location comprises determining the touch location using less than all of the calculated distances.

11. A touch sensing device, comprising:
a touch panel;
a plurality of sensors coupled to the touch panel, the plurality of sensors configured to sense dispersive vibrations in the touch panel and generate a sense signal responsive to the sensed dispersive vibrations; and
a controller coupled to the plurality of sensors and configured to calculate a distance between a touch on the touch panel and each of the sensors based on an amount of dispersion present in the sense signal generated by each of the sensors, the controller configured to determine a location of the touch on the touch panel using at least some of the calculated distances.

12. The device of claim 11, wherein the controller determines the touch location using all of the calculated distances.

13. The device of claim 11, wherein the controller determines the amount of dispersion present in the sense signals based on predetermined content in the sense signals.

14. The device of claim 11, wherein the controller determines the amount of dispersion present in the sense signals based on content in the sense signals associated with each of a plurality of frequencies.

15. The device of claim 11, wherein the controller determines the amount of dispersion present in the sense signals based on content in the sense signals associated with each of a plurality of frequency bands.

16. The device of claim 11, wherein the controller determines the amount of dispersion present in the sense signals based on predetermined frequency and amplitude characteristics of the sense signals.

17. The device of claim 11, wherein the controller determines the touch location by determining intersections of circular arcs computed using the at least some of the calculated distances.

18. The device of claim 11, wherein the controller determines the touch location using less than all of the calculated distances.

19. A device for determining a location of a touch on a touch sensitive plate, the device comprising:
means for sensing dispersive vibrations caused by the touch on the touch plate at each of a plurality of locations of the touch sensitive plate;
means for determining an amount of dispersion in the dispersive vibrations sensed at each of the touch sensitive plate locations;
means for calculating a distance between the touch and each of the touch sensitive plate locations based on the amount of dispersion in the dispersive vibrations sensed at each of the touch sensitive plate locations; and
means for determining the touch location using at least some of the calculated distances.

20. The device of claim 19, wherein the means for determining the amount of dispersion comprises means for determining the amount of dispersion based on one or both of predetermined frequency and amplitude characteristics of the dispersive vibrations sensed at each of the touch sensitive plate locations.
